(19) United States
(12) Patent Application Publication
(10) Pub. No.: US 2021/0121268 A1
(43) Pub. Date: Apr. 29, 2021

(54) MAGNETIC ORTHODONTIC DEVICE

(71) Applicants: WEN-KEN TAI, TAICHUNG CITY (TW); CHANG-ER NIEN, TAICHUNG CITY (TW)

(72) Inventors: WEN-KEN TAI, TAICHUNG CITY (TW); CHANG-ER NIEN, TAICHUNG CITY (TW)

(21) Appl. No.: 16/736,986

(22) Filed: Jan. 8, 2020

(30) Foreign Application Priority Data
Oct. 25, 2019 (TW) 108138544

(51) Int. Cl. A61C 7/14; A61C 7/00

(52) U.S. Cl. CPC A61C 7/146; A61C 7/006

(57) ABSTRACT

A magnetic orthodontic device has an aligner and a magnet. The aligner has at least one connecting portion and at least one assembling portion. The at least one connecting portion is adapted to be connected to a tooth or an alveolar bone of a patient. The at least one assembling portion is respectively disposed at the at least one connecting portion. The at least one magnet is respectively assembled to the at least one assembling portion.

### BACKGROUND OF THE INVENTION

### 1. Field of the Invention

The present invention relates to a device for orthodontia, and more particularly to a magnetic orthodontic device that can reduces the orthodontic treatment time.

### 2. Description of Related Art

Orthodontic aligners are applied to correct malocclusion such as under bite, over bite, deep overbite, or open bite. A traditional orthodontic device has a bracket, an archwire, and an elastomeric ligature. The bracket and the archwire are metallic. The bracket is attached to teeth via adhesive, and the archwire is held to the bracket with the elastomeric ligature. The pulling interaction between the brace and the archwire guides the teeth into a desired orientation.

The traditional orthodontic device has an uneven contour. The uneven contour of the traditional orthodontic device causes food debris to easily stick to the bracket, results in difficulty in cleaning the bracket, and raises the risk of tooth decay. More particularly, the uneven contour of the traditional orthodontic device continually rubs the interior of the mouth, causes a foreign body sensation in the mouth, and reduces the aesthetic appearance.

In order to overcome the above-mentioned drawbacks of the traditional orthodontic device, a clear aligner manufactured by 3D printing is invented. The clear aligner provides better wearing experience without reducing the aesthetic appeal of the patient.

However, the clear aligner still has the following defects:

1. The clear aligner is mounted on crowns of teeth. When the crowns are abutted by the clear aligner and forced to move, the force provided by the clear aligner is transmitted from the crowns to periodontal ligament, and roots of teeth slowly move consequently. Therefore, the progressive orthodontic treatment via the clear aligner takes a long period of time.

2. The orthodontic treatment via the clear aligner requires sixty to seventy sets of clear aligner for gradually correcting teeth orientation. The number of sets of clear aligner is determined according to various orthodontic treatments and treatment time. Therefore, the orthodontic treatment via the clear aligners causes high expense of producing clear aligners.

3. In order to fix the clear aligner to the teeth, an engaging member is attached to the teeth, and the clear aligner has a corresponding recess for engaging with the engaging member. However, the engaging member is made of UV curable resin and is prone to wearing out by the clear aligner and fails to engage with corresponding recess of the clear aligner. In addition, the engaging member is easily detached from the teeth and fails to fix the clear aligner when the patient has poor oral hygiene. Therefore, the clear aligner can be inadvertently detached from teeth.

To overcome the shortcomings of the clear aligner, the present invention provides a magnetic orthodontic device to mitigate or obviate the aforementioned problems.

### SUMMARY OF THE INVENTION

The main objective of the present invention is to provide a magnetic orthodontic device to shorten orthodontic treatment time.

The magnetic orthodontic device comprises an aligner and a magnet. The aligner has at least one connecting portion and at least one assembling portion. The at least one connecting portion is adapted to be connected to a tooth or an alveolar bone. The at least one assembling portion is respectively disposed at the at least one connecting portion. The at least one magnet is respectively assembled to the at least one assembling portion.

The magnetic orthodontic device in accordance with the present invention corrects teeth orientation via attraction and repelling between magnets and can reduce orthodontic treatment time and lower expense of producing clear aligners. Moreover, the magnets are more wear-resistant than engaging members made of UV curable resin and prolong service life of the magnet orthodontic device.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a magnet orthodontic device in accordance with the present invention;

FIG. 2 is a perspective view of a second embodiment of a magnet orthodontic device in accordance with the present invention;

FIG. 3 is a perspective view of a third embodiment of a magnet orthodontic device in accordance with the present invention;

FIG. 4 is a cross sectional side view of the magnet orthodontic device along line 4-4 in FIG. 3;

FIG. 5 is an operational perspective view of a first treatment using the magnet orthodontic devices in accordance with the present invention;

FIG. 6 is an operational perspective view of a second treatment using the magnet orthodontic devices in accordance with the present invention;

FIG. 7 is an operational perspective view of a third treatment using the magnet orthodontic devices in accordance with the present invention;

FIG. 8 is an operational perspective view of a fourth treatment using the magnet orthodontic devices in accordance with the present invention;

FIG. 9 is an operational perspective view of a fifth treatment using the magnet orthodontic devices in accordance with the present invention;

FIG. 10 is an operational perspective view of a sixth treatment using the magnet orthodontic devices in accordance with the present invention; and

FIG. 11 is an operational perspective view of a seventh treatment using the magnet orthodontic devices in accordance with the present invention.

### DETAILED DESCRIPTION OF PREFERRED EMBODIMENTS

A magnetic orthodontic device in accordance with the present invention has three embodiments. Each embodiment of the present invention has an aligner and at least one magnet mounted to the aligner.

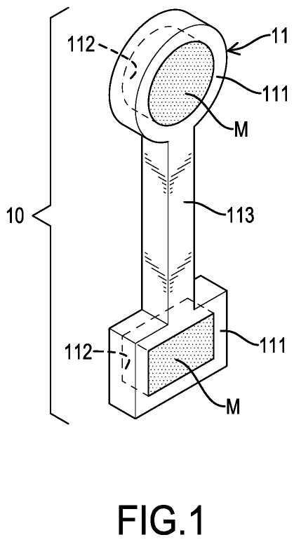

With reference to FIG. 1, a first embodiment of the present invention is a first orthodontic device 10 of a first configuration. The first orthodontic device 10 has a first aligner 11 and two magnets M. The first aligner 11 has two connecting portions 111, two assembling portions 112, and a linkage portion 113. The linkage portion 113 is elongated and has two opposite ends. The two connecting portions 111 are respectively connected to the two opposite ends of the linkage portion 113. The connecting portions 111 of the first aligner 11 are designed to increase an attachment area between the first aligner 11 and a tooth to be firmly connected to a tooth. One of the two connecting portions 111 has a circular contour. The other one of the two connecting portions 111 has a rectangular contour.

With reference to FIG. 1, the two assembling portions 112 are respectively defined in the two connecting portions 111. Each one of the two assembling portions 112 may be a recess or a through hole for receiving a respective one of the two magnets M. The two magnets M are respectively embedded in the two assembling portions 112.

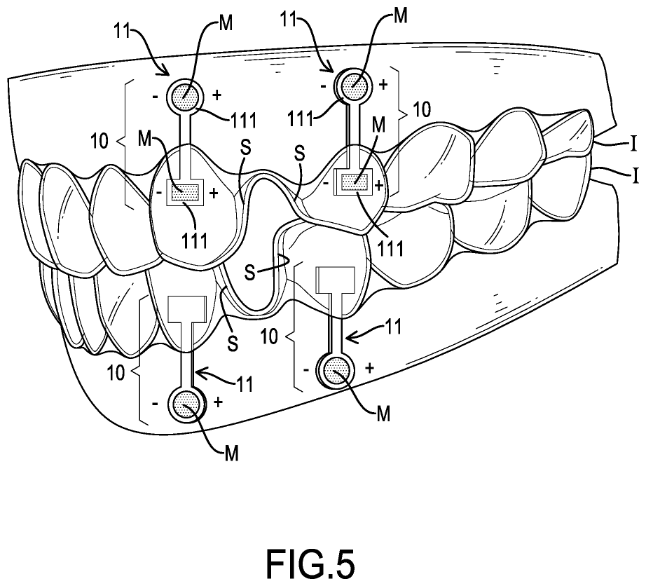

With reference to FIG. 5, in the first embodiment, the first aligner 11 has only one assembling portion 112, which is defined in one of the two connecting portions 111 of the first aligner 11. There may be only one magnet M accordingly embedded in the assembling portion 112.

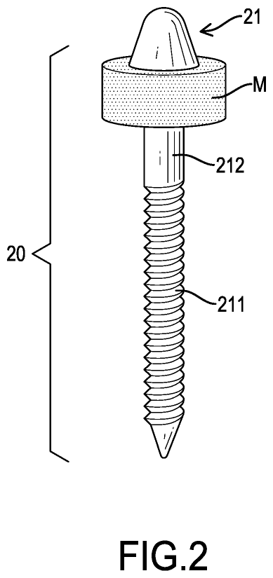

With reference to FIG. 2, a second embodiment of the present invention is a second orthodontic device 20 of a second configuration. The second orthodontic device 20 has a second aligner 21 and a magnet M. The second aligner 21 is a temporary anchorage device, TAD, and is shaped like a pole and has two opposite ends, a connecting portion 211, and an assembling portion 212. The connecting portion 211 is disposed at one of the two opposite ends of the second aligner 21 and has a thread. The assembling portion 212 is disposed adjacent to the other end of the second aligner 21. The magnet M is mounted on the assembling portion 212.

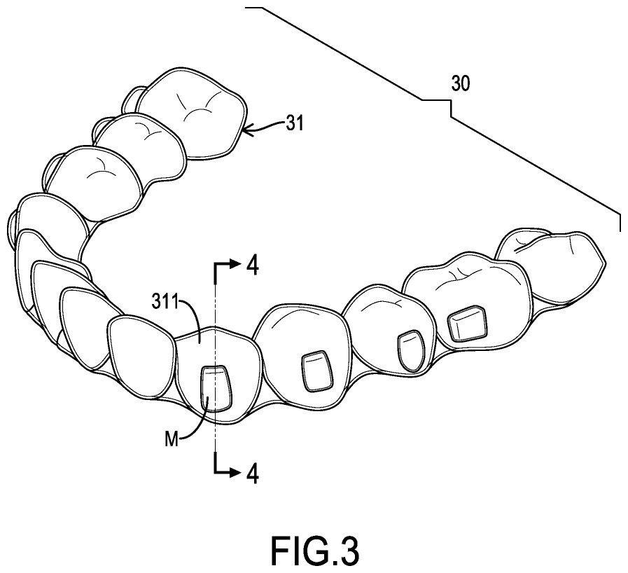

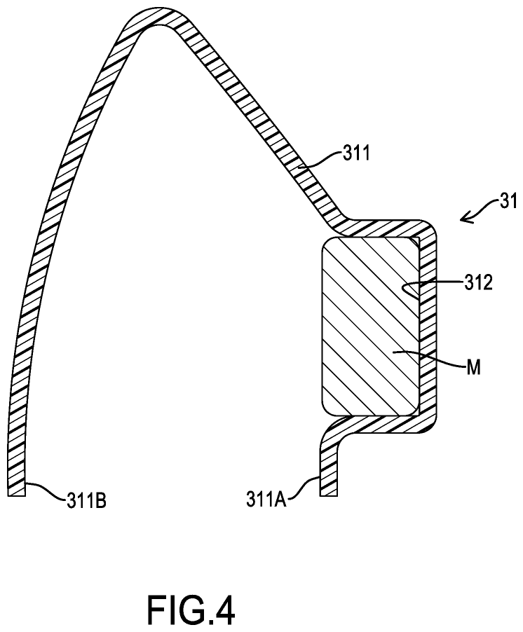

With reference to FIGS. 3 and 4, a third embodiment of the present invention is a third orthodontic device 30 of a third configuration. The third orthodontic device 30 has a third aligner 31 and multiple magnets M. The third aligner 31 is a brace with a U-shaped contour and has a connecting portion 311 and multiple assembling portions 312. The connecting portion 311 has a U-shaped cross-section and two inner peripheral surfaces 311A, 311B facing to each other. The multiple assembling portions 312 are defined in one of the two inner peripheral surfaces 311A. The multiple magnets M are respectively embedded in the multiple assembling portions 312.

With reference to FIGS. 1 and 5, a first treatment using the magnet orthodontic devices in accordance with the present invention is applied to lower teeth as illustrated in FIG. 5. In the first treatment, two said first orthodontic devices 10 are accompanied with a clear aligner I for orthodontic treatment with teeth extraction. In the first treatment, each first orthodontic device 10 has one said magnet M. The aligner 11 of each orthodontic device 10 has one said assembling portion 112 defined in a respective one of the two connecting portions 111 of the aligner 11. The magnet M of each first orthodontic device 10 is embedded in the assembling portion 112 of the aligner 11 of the first orthodontic device 10. With reference to FIG. 5, the assembling portion 112 of the aligner 11 of each first orthodontic device 10 is defined in a respective one of the aligner's connecting portions 111 that has a circular contour. The two aligners 11 of the two first orthodontic devices 10 are respectively connected to two crowns of two of the lower teeth. Each aligner 11 is connected to the crown via the rectangular connecting portion 111 of the aligner 11. The clear aligner I is connected to crowns of the lower teeth. Two gaps S are respectively formed between the clear aligner I and the corresponding two teeth respectively connected with the two aligners 11 of the two first orthodontic devices 10. The two gaps S provide enough spaces for movements of the corresponding two teeth. When the two magnets M of the two first orthodontic devices 10 attract, two roots of the corresponding two teeth approach each other. The two crowns of the corresponding two teeth are pushed by the clear aligner I and approach each other. Therefore, the corresponding two teeth slowly approach each other to accomplish orthodontic treatment with teeth extraction. The teeth orientation is corrected via both the two first orthodontic devices 10 and the clear aligner I. The crowns and roots of the teeth approach each other simultaneously. Therefore, the orthodontic treatment is accelerated.

With reference to FIGS. 1 and 5, the first treatment using the magnet orthodontic devices in accordance with the present invention can also be applied to upper teeth as shown in FIG. 5. Two first orthodontic devices 10 are respectively connected to two of the upper teeth. Each first orthodontic device 10 has two said magnets M. The aligner 11 of each first orthodontic device 10 has two assembling portions 112 respectively defined in the two connecting portions 111 of the aligner 11 of the first orthodontic device 10. The two magnets M of each first orthodontic device 10 are respectively embedded in the two assembling portions 112 of the aligner 11 of the first orthodontic device 10. The connecting portion 111 with a rectangular contour of each first orthodontic device 10 is connected to a corresponding one of the upper teeth. The upper teeth in FIG. 5 are also corrected both via the two first orthodontic devices 10 and the clear aligner I mounted on the upper teeth. Therefore, the orthodontic treatment is also speeded up.

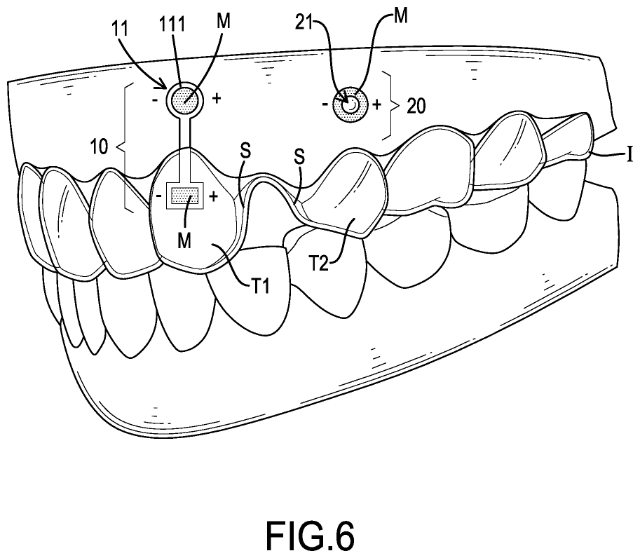

With reference to FIGS. 1, 2, and 6, a second treatment of the magnet orthodontic devices in accordance with the present invention is applied to upper teeth in FIG. 6. In the second treatment, one said first orthodontic device 10 and one said second orthodontic device 20 are accompanied with one said clear aligner I for orthodontic treatment of canines. In the second treatment, the first orthodontic device 10 has two said magnets M, and the aligner 11 of the first orthodontic device 10 has two said assembling portions 112 respectively defined in the two connecting portions 111 of the aligner 11 for receiving the two magnets M. The aligner 11 is connected to one of canines T1 of the upper teeth via one of the two connecting portions 111 having a rectangular contour. The connecting portion 211 of the second orthodontic device 20 is screwed with alveolar bone at a position near one of first molars T2 of the upper teeth. A gap S is formed between the canine T1 and the clear aligner I to provide enough space for movement of the canine T1. When the magnets M of the first orthodontic device 10 and the magnet M of the second orthodontic device 20 attract, the canine T1 moves toward the first molar T2.

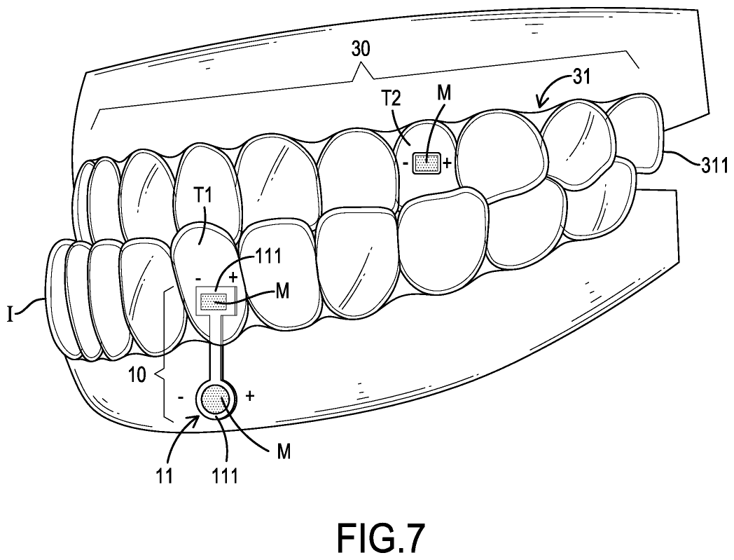

With reference to FIGS. 1, 4, and 7, a third treatment of the magnet orthodontic devices in accordance with the present invention is applied to lower teeth and upper teeth in FIG. 7. In the third treatment, one said first orthodontic device 10 and one said third orthodontic device 30 are accompanied with one said clear aligner I for orthodontic treatment of underbite. The first orthodontic device 10 and the clear aligner I are attached to the lower teeth. The first orthodontic device 10 has two said magnets M. The aligner 11 of the first orthodontic device 10 is connected to one of canines T1 of the lower teeth via one of the two connecting portions 111 with a rectangular contour. The third orthodontic device 30 is mounted on the upper teeth. The third orthodontic device 30 has a magnet M. The aligner 31 has an assembling portion 312 for receiving the magnet M. The assembling portion 312 is disposed according to a position of one of the first molars T2 of the upper teeth. When the magnet M of the first orthodontic device 10 and the magnet M of the third orthodontic device 30 attract, the first orthodontic device 10 and the third orthodontic device 30 approach each other to align the upper teeth and the lower teeth.

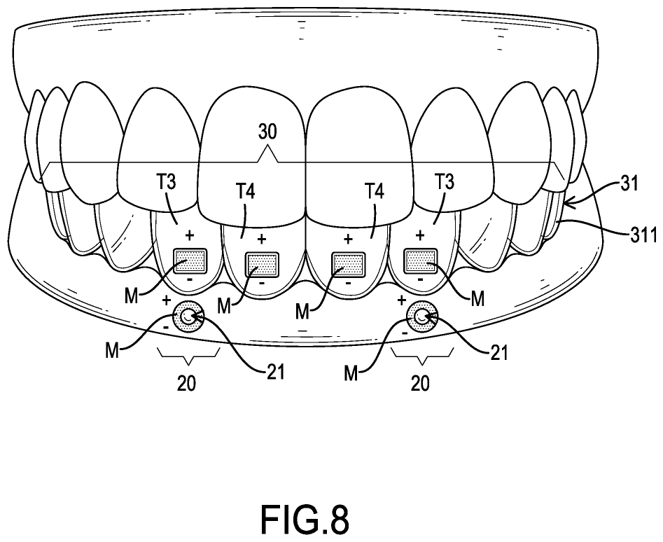

With reference to FIGS. 2, 4, and 8, a fourth treatment using the magnet orthodontic devices in accordance with the present invention is applied to lower teeth. In the fourth treatment, two said second orthodontic devices 20 are accompanied with one said third orthodontic device 30 for orthodontic treatment of deep overbite. The two connecting portions 211 of the two aligners 21 of the two second orthodontic devices 20 are screwed with the alveolar bone of mandible and respectively disposed below two lateral incisors T3 of the lower teeth. The third orthodontic device 30 is mounted on the lower teeth via the aligner 31 of the third orthodontic device 30 and has four magnets M. The aligner 31 of the third orthodontic device 30 has four assembling portions 312 for respectively receiving the four magnets M of the third orthodontic device 30. When the magnets M of the two second orthodontic devices 20 and the magnets M of the third orthodontic device 30 attract, the lower teeth move downward to move away from the upper teeth for correcting deep overbite.

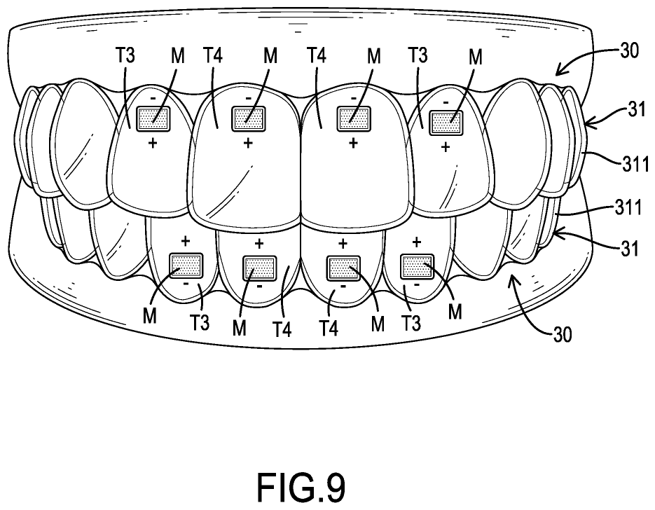

With reference to FIGS. 4 and 9, a fifth treatment of the magnet orthodontic devices in accordance with the present invention is applied to lower teeth and upper teeth in FIG. 9. Two said third orthodontic devices 30 are respectively mounted on the upper teeth and the lower teeth for orthodontic treatment of deep overbite. Each third orthodontic device 30 has four said magnets M. The aligner 31 of each third orthodontic device 30 has four said assembling portions 312. The four magnets M of each third orthodontic device 30 are respectively embedded in the four assembling portions 312 of the aligner 31 of the third orthodontic device 30. The four magnets M of the third orthodontic device 30 mounted on the upper teeth are arranged according to two central incisors T4 and two lateral incisors T3 of the upper teeth in position. The four magnets M of the third orthodontic device 30 mounted on the lower teeth are arranged according to two central incisors T4 and two lateral incisors T3 of the lower teeth in position. When the magnets M of the two third orthodontic devices 30 repel, the two third orthodontic devices 30 move away from each other. Therefore, the upper teeth and the lower teeth move away from each other.

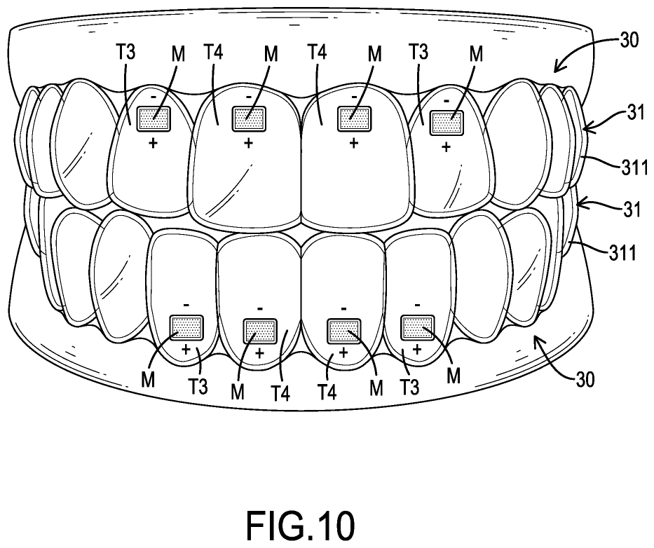

With reference to FIGS. 4 and 10, a sixth treatment using the magnet orthodontic devices in accordance with the present invention is applied to lower teeth and upper teeth. In the sixth treatment, two said third orthodontic devices 30 are respectively mounted on the lower teeth and the upper teeth for orthodontic treatment of open bite. Each third orthodontic device 30 has four magnets M. The aligner 31 of each third orthodontic device 30 has four assembling portions 312. The four magnets M of each third orthodontic device 30 are respectively embedded in the four assembling portions 312 of the aligner 31 of the third orthodontic device 30. The four magnets M of the third orthodontic device 30 mounted on the upper teeth are arranged according to two central incisors T4 and two lateral incisors T3 of the upper teeth in position. The four magnets M of the third orthodontic device 30 mounted on the lower teeth are arranged according to two central incisors T4 and two lateral incisors T3 of the lower teeth in position. When the magnets M of the two third orthodontic devices 30 attract, the two third orthodontic devices 30 approach each other. Therefore, the upper teeth and the lower teeth move toward each other.

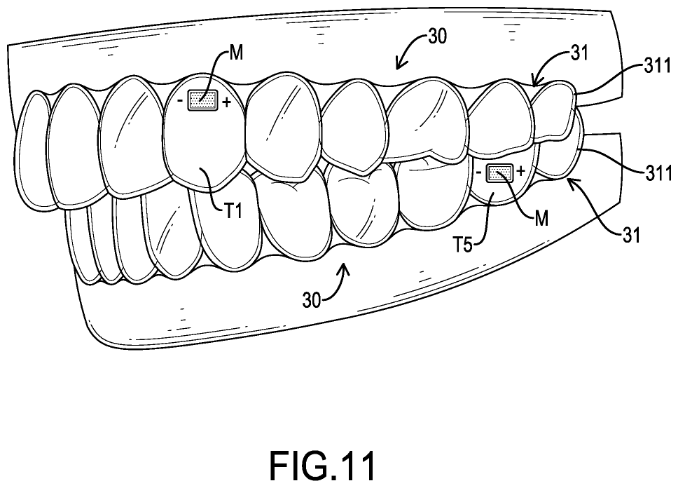

With reference to FIGS. 4 and 11, a seventh treatment using the magnet orthodontic devices in accordance with the present invention is applied to lower teeth and upper teeth. Two said third orthodontic devices 30 are respectively mounted on the upper teeth and the lower teeth. Each third orthodontic device 30 has a magnet M. The aligner 31 of each third orthodontic device 30 has one said assembling portion 312. The magnet M of each third orthodontic device 30 is embedded in the assembling portion 312 of the aligner 31 of the third orthodontic device 30. The magnet M of one of the third orthodontic devices 30 mounted on the upper teeth is arranged according to one of the canines T1 of the upper teeth in position. The magnet M of the other one of the third orthodontic devices 30 is arranged according to one of the second molars T5 of the lower teeth in position. When the magnets M of the two third orthodontic devices 30 attract, the two third orthodontic devices 30 approach each other to align the upper teeth and the lower teeth.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A magnetic orthodontic device comprising:
an aligner having
at least one connecting portion adapted to be connected to teeth or an alveolar bone; and
at least one assembling portion respectively disposed at the at least one connecting portion; and
at least one magnet respectively assembled to the at least one assembling portion.

2. The magnetic orthodontic device as claimed in claim 1, wherein
the aligner has a linkage portion being elongated and having two opposite ends;
the at least one connecting portion is two connecting portions respectively connected to the two opposite ends of the linkage portion;
the at least one assembling portion is one assembling portion defined in one of the two connecting portions; and
the at least one magnet is one magnet embedded in the assembling portion.

3. The magnetic orthodontic device as claimed in claim 1, wherein
the aligner has a linkage portion being elongated and having two opposite ends;
the at least one connecting portion is two connecting portions respectively connected to the two opposite ends of the linkage portion;
the at least one assembling portion is two assembling portions respectively defined in the two connecting portions; and
the at least one magnet is two magnets respectively embedded in the two assembling portions.

4. The magnetic orthodontic device as claimed in claim 1, wherein
the aligner is a temporary anchorage device, is shaped as a pole, and has two opposite ends;
the at least one connecting portion is one connecting portion disposed at one of the two opposite ends of the aligner and having a thread;
the at least one assembling portion is one assembling portion disposed adjacent to the other one of the two opposite ends of the aligner; and
the at least one magnet is one magnet mounted on the assembling portion.

5. The magnetic orthodontic device as claimed in claim 1, wherein
the aligner is a brace and has a U-shaped contour;
the at least one connecting portion is one connecting portion having a U-shaped cross-section and two inner peripheral surfaces facing to each other;
the at least one assembling portion is defined in one of the two inner peripheral surfaces of the connecting portion; and
the at least one magnet is respectively embedded in the at least one assembling portion.
